(19) United States
(12) Patent Application Publication
(10) Pub. No.: US 2005/0084628 A1
(43) Pub. Date: Apr. 21, 2005

(54) Method for achieving a two-tone finish on a vehicle

(76) Inventors: Robert Bruce Williams, Troy, MI (US); San C. Yuan, Commerce Township, MI (US); Mary Ann Haslett, Lake Orion, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/688,616

(22) Filed: Oct. 17, 2003

(51) Int. Cl. B60R 13/00; B05D 3/02

(52) U.S. Cl. 428/31; 427/402; 427/372.2

(57) ABSTRACT

A method for achieving a multiple colored two-tone finish on a variety of substrates, by (1) applying a holdout capable chip resistant primer coating composition to an accent area of a substrate, typically previously painted with an electrodeposition primer composition, (2) applying a primer surfacer coating composition to an adjacent non-accent area of the substrate, (3) applying an accent color basecoating composition wet-on-wet to the chip resistant primer coating composition in the accent area, (4) curing the composite coated substrate in a first bake, (5) covering the accent area with a protective membrane, (6) applying a main color basecoating composition over the unmasked area, (7) removing the protective membrane from the accent area, (8) applying a clear coating composition wet-on-wet to all faces of the substrate, and then (9) curing the composite two-toned coated substrate in a second bake, is claimed.

### BACKGROUND OF THE INVENTION

This invention relates to coating methods for producing a multiple colored, two-tone, finish on a substrate such as an automobile or truck requiring only two curing cycles, as well as a substrate coated according to the above methods.

Transportation vehicles, such as automobile and truck bodies, are treated with multiple layers of coatings which enhance the appearance of the vehicle and also provide protection from corrosion, scratch, chipping, ultraviolet light, acid rain and other environmental conditions. Basecoat/clearcoat finishes for automobiles and trucks have been commonly used over the past two decades, in a “wet-on-wet” application, i.e., the clear coat is applied before the base coat is completely cured. In typical fashion, the basecoat/clearcoat finish is typically applied over a previously cured primer surfacer coated substrate. It is also common to apply a special chip resistant primer in the low body areas of automobile and truck bodies, during the primer surfacer application stage.

The desire for even more unique and attractive color styling has led the automobile and truck Original Equipment Manufacturers (OEM) produce vehicles with multiple colored, or “two-toned,” finishes. A typical procedure used to produce a chip resistant “two-tone” finished vehicle substrate involves the following:
I) Application of a lower body chip resistant primer over an electrocoated vehicle substrate;
II) Application of a primer surfacer to the entire substrate;
Ill) Bake curing the prime coated substrate;
IV) Applying a main body color basecoat to the vehicle substrate;
V) Applying clearcoat over the main color basecoat;
VI) Bake curing and covering with a protective membrane, the upper body main color basecoat/clearcoat finish area of the substrate;
VII) Applying accent color in accent area
VIII) Applying accent clear in accent area
IX) Bake curing the accent basecoaticlearcoat finish, and removing the protective membrane.

Accordingly, producing a chip resistant two-tone finished vehicle substrate typically involves three bake curing cycles and six coating stages, including passing the vehicle substrate through the basecoat/clearcoat finishing stages on two separate occasions. Several practical disadvantages arise with this typical procedure. These include two separate clearcoating steps, one additional bake curing cycle, and most notably, the requirement to pass the vehicle substrate through the basecoat/clearcoat finishing stages on two separate occasions tying up the vehicle assembly line and producing a production bottleneck. This last disadvantage is time consuming, energy demanding, and not cost effective.

Therefore, there is a need for a coating composition and application methods which provide multiple colored two-tone finishes in a minimum number of coating layers and bake curing cycles.

### SUMMARY OF THE INVENTION

The present invention is directed to a method for achieving a multiple colored two-tone finish on a variety of substrates, typically on portions of automobile and truck exteriors such as on window and door frames, and other body parts. The method comprises:
(1) applying a chip resistant primer coating composition with holdout capability to an accent area of a substrate, typically previously painted with an electrodeposition primer composition;
(2) applying a primer surfacer coating composition to an adjacent non-accent area of the substrate;
(3) applying an accent color basecoating composition wet-on-wet to the chip resistant primer coating composition in the accent area;
(4) curing the composite coated substrate from step (3) in a first bake;
(5) covering the accent area with a protective membrane;
(6) applying a main color basecoating composition over the unmasked area;
(7) removing the protective membrane from the accent area; and then
(8) applying a clear coating composition wet-on-wet to all faces of the substrate from step (7); and then
(9) curing the composite two-toned coated substrate from step (8) in a second bake.

The method of this invention can be operated in a single pass continuous in-line paint application process or in stationary batch process, at a vehicle assembly plant.

The method eliminates the need for a separate lower body urethane chip resistant primer requiring a separate bake, resulting in substantial savings without sacrificing chip performance.

A coated substrate having a two-tone composite coating prepared according to the present method also forms part of this invention.

### BRIEF DESCRIPTION OF THE DRAWINGS

FIG. 1 is a general flow diagram of a two-tone coating scenario illustrating a method the present invention.

FIG. 2 is a general flow diagram of a conventional two-tone coating method of the prior art.

FIG. 3 is a graphic illustration of a process for applying a two-tone finish on a vehicle substrate according to an embodiment of present invention.

### DETAILED DESCRIPTION OF THE INVENTION

The present invention is directed to a process for forming a multi-colored two-tone composite finish on a variety of substrates, especially on portions of automobile and truck bodies and parts thereof. The process of the present invention can be run in a batch or continuous process. Ideally, it is designed to be run in existing primer surfacer/basecoat/clearcoat painting facilities, such as continuous in-line or modular batch facilities, located at an automotive assembly plant without the need for double processing of a vehicle through the paint line or the need to extend the painting time.

By replacing the conventional accent area chip resistant urethane primer with a “holdout” capable chip resistant primer composition capable of wet-on-wet application with a basecoat, the number of steps and curing cycles in the conventional two-tone painting process can be reduced, yet without sacrificing chip resistant performance in the accent area.

The term “holdout capable” means a recently applied uncured initial coating possesses intermixing resistance and maintains a substantial interfacial boundary when a secondary coating layer, or plurality of coatings layers, are subsequently applied over the initial coating layer. This type of multiple coating technique without curing between layers is commonly referred to as “wet-on-wet” when two wet coats are used, or “wet-on-wet-on-wet” for three wet coating layers.

By “two-tone” it is meant that a vehicle finish has two distinctly different colors. A first accent color which covers a minor portion of the vehicle's outer substrate, usually in the lower or middle vertical area. A second main body color that covers the remaining major portion of the vehicle's outer substrate.

The terminology “protective membrane” is defined as a pliable film which possesses the characteristics to cover and shield a first cured coating layer from exposure to subsequently applied second coating layer, thus maintaining the integrity of the first cured coating layer. The protective membrane may be secured in place by any practical means, such as tape, or adhesive. Such protective membranes are widely available in the marketplace. Vector Technologies of Grand Blanc, Mich., supplies a particularly useful protective membrane that has an adhesive deposited on the membrane, which is self adherent and does not require tape to secure the membrane.

In an embodiment of the present invention, a chip resistant curable coating composition with holdout capability is applied to an accent area of a substrate, a second curable primer surfacer coating is applied to an adjacent non-accent area, and then an accent color basecoat coating is applied to the aforementioned chip resistant curable coated accent area. The above composite coating is then cured, and the color accent area is subsequently covered with a protective membrane. Then, a main color basecoat is applied, the protective membrane removed, and then substrate surface is clearcoated and cured in a second bake.

In yet another embodiment of the present invention, a chip resistant curable coating composition with holdout capability is applied to the entire substrate, and then an accent color basecoat coating is applied to the aforementioned chip resistant curable coated in the accent area. The above composite coating is then cured, and the color accent area is subsequently covered with a protective membrane. Then, a main color basecoat is applied, the protective membrane removed, and then substrate surface is clearcoated and cured in a second bake.

Also, the invention is directed to a coated substrate. The coated substrate is prepared according to the methods described, using the holdout capable curable coating composition of the invention. The coated substrate may be, for example, a transportation vehicle substrate such as an automotive, truck, airplane, or vessel.

FIG. 1 is a flow diagram illustrating an embodiment of the present invention. This method produces a two-tone finish utilizing a three wet coat integrated first stage, which is cured, followed by a second stage in which a colored basecoat and clearcoat are applied as a composite and cured. This finished substrate also has excellent chip resistance, as well as adhesion, intercoat adhesion, appearance, and other desired film properties.

Referring to FIG. 1, in step 2, an electrocoated vehicle substrate enters a two-tone coating scenario, wherein a holdout capable chip resistant curable coating composition is applied to an accent area of the vehicle substrate, step 4. Subsequently, in step 6, a second curable primer surfacer coating is then applied to the non-accent area, and in step 8 an accent color basecoat coating is applied to the aforementioned chip resistant curable coating layer. The above wet-on-wet accent area layers, as well as the primed non-accent areas are then cured in step 10, at an effective time and temperature combination.

Referring once again to FIG. 1, after curing, in step 12 the color coated accent area is covered with a protective membrane and secured in place. The main body color basecoat is then applied to the vehicle substrate per step 14. The color coated accent area is then uncovered in step 16, a clearcoat is applied to the entire outer substrate of the vehicle per step 18, and the composite coating is cured in step 20.

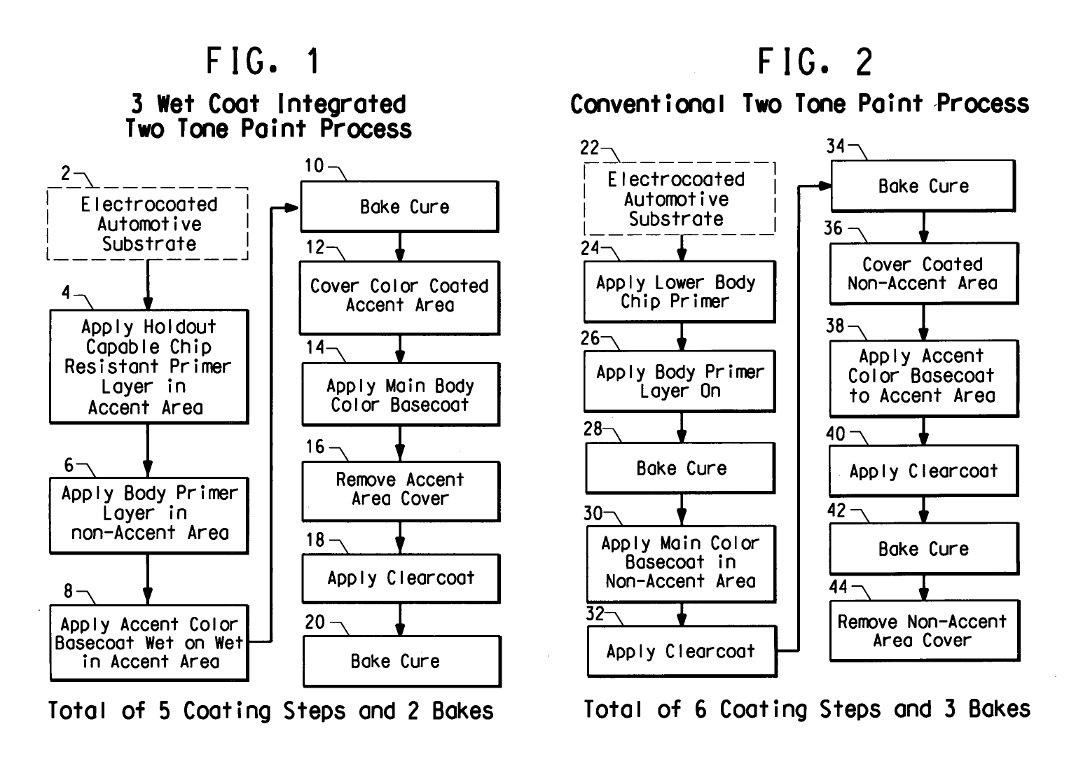

In order to illustrate the advantage of the present invention over the conventional technique to achieve a chip resistant two-tone finish, refer to FIG. 2. As FIG. 2 indicates, a lower body chip resistant primer is applied over an electrocoated vehicle substrate in steps 22 and 24. Then a primer surfacer is applied to the entire substrate per step 26, and the chip resistant and primer layers are cured, step 28. In steps 30 and 32, a main body color basecoat is applied to the non-accent area of the vehicle substrate, and clearcoat is then applied. The layers are then bake cured and covering with a protective membrane, per steps 34 and 36. An accent color basecoat is then applied to the accent area of the vehicle substrate, and clearcoated in accordance with steps 38 and 40. Finally, the accent color basecoat/clearcoat finish is bake cured, and the protective membrane removed, steps 42 and 44.

In summary, the conventional two-tone method consists of a total of 6 coating steps and 3 bake curing steps. In one embodiment of the present invention, a two-tone chip resistant finish is achieved in 5 coating steps and 2 bake curing steps. In yet another embodiment, the finish is achieved in 4 coating steps and 2 bake curing steps.

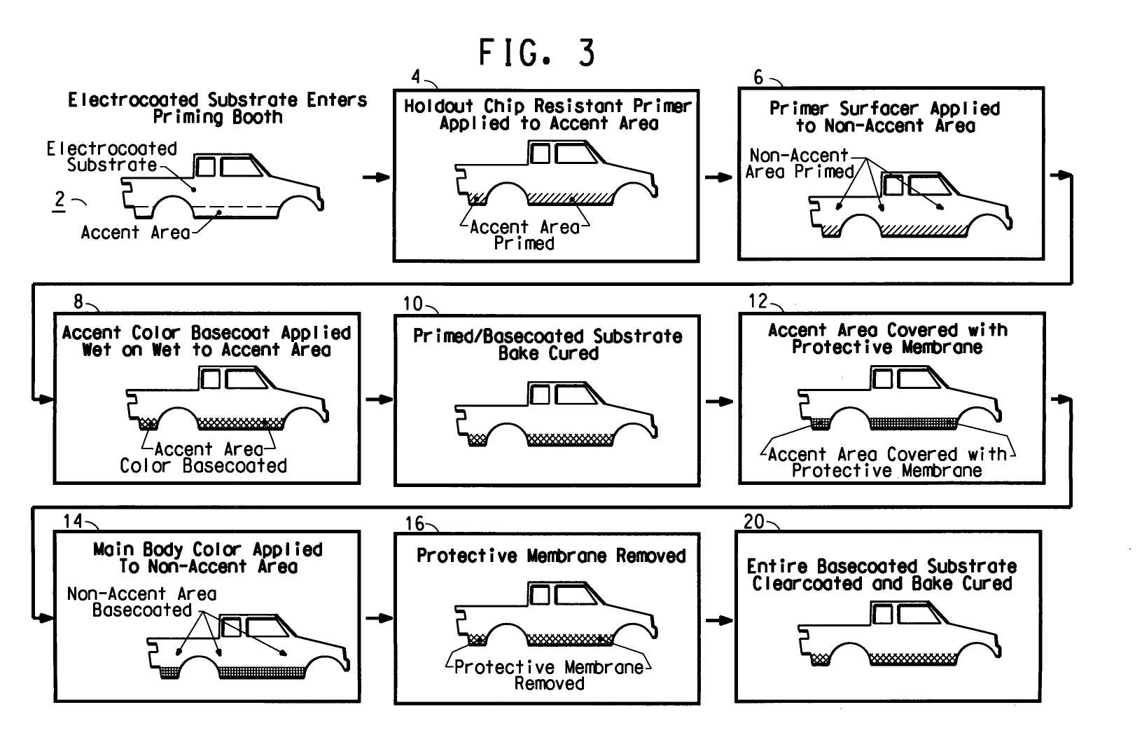

FIG. 3 is a graphic representation which further illustrates the embodiment described in FIG. 1, to produces a two-tone finish utilizing a three wet coat integrated first stage. This finished substrate also has excellent chip resistance, as well as adhesion, intercoat adhesion, appearance, and other desired film properties.

Referring to FIG. 3 (which uses the same reference numerals as used in FIG. 1), in step 2, an electrocoated vehicle substrate enters a primer coating booth, step 2, wherein a holdout capable chip resistant curable coating composition is applied to an accent area of the vehicle substrate, step 4. Then a second curable primer surfacer coating is then applied to the non-accent area in step 6. In step 8 an accent color basecoat coating is applied over the previously applied capable chip resistant curable coating layer. The above wet-on-wet-on wet layers are cured in step 10.

As FIG. 3 further illustrates, after curing, in step 12 the color coated accent area is covered with a protective membrane and secured in place. The main body color basecoat is then applied to the vehicle substrate per step 14, and the protective membrane removed, step 16. A clearcoat is applied to the entire outer substrate of the vehicle (not shown in FIG. 3) and the composite coating is baked cured, step 20.

In an alternative method of the present invention, the aforementioned holdout capable chip resistant curable coating composition can be also used as the main body primer surfacer. Referring again to FIG. 3, the primer would be applied to the entire vehicle, combining steps 4 and 6. This scenario may be considered a wet-on-wet application method.

The flash times between wet coats and bake curing time and temperatures will be readily apparent to those of skill in the art, and may be controlled by the specific coating chemistry or formulations. Generally though, flash times between uncured wet coats can range from about 15 seconds to 10 minutes, bake curing temperatures can range from about 100° C. to 160° C., and cure times can range from about 15 to 45 minutes.

The thickness of the cured composite two-tone finish is generally from about 50 to 275 μm (2 to 12 mils) and preferably about 100 to 200 μm (4 to 8 mils). The primers, basecoats, and clearcoat are preferably applied and cured to have thicknesses from about 10 to 50 μm (0.4 to 2.0 mils), about 10 to 50 μm (0.4 to 2.0 mils), and about 25 to 75 μm (1.0 to 3.0 mils), respectively.

The holdout capable chip resistant primer coating used in the present invention must possess intermixing resistance with other basecoat and primer coatings are subsequently applied wet-on-wet, or wet-on-wet-on-wet, thereon. Further, the primer should impart chip resistance into the finish to enable the elimination of a lower body chip resistant urethane primer.

The nature of the clearcoat or basecoat composition employed in any method of the present invention is in no way critical. The primer, though, should possess the aforementioned properties. Any of a wide variety of commercially available automotive clearcoats, basecoat, or primer compositions may be employed in the present invention, including standard solvent borne, waterborne or powdered based systems. High solids solvent borne clearcoats, basecoats, and primer surfacers which have low VOC (volatile organic content) and meet current pollution regulations are more commonly employed. Typically useful solventborne coatings include but are not limited to 2K (two component) systems of polyol polymers crosslinked with isocyanate and 1K systems of acrylic polyol crosslinked with melamine or 1K acrylosilane systems in combination with polyol and melamine. Epoxy acid systems can also be used. Such finishes provide automobiles and trucks with a mirror-like exterior finish having an attractive aesthetic appearance, including high gloss and DOI (distinctness of image). Suitable 1K solvent borne acrylosilane clearcoat systems that can be used in the process of the present invention are disclosed in U.S. Pat. No. 5,162,426, hereby incorporated by reference. Suitable 1K solvent borne acrylic/melamine clearcoat systems are disclosed in U.S. Pat. No. 4,591,533, hereby incorporated by reference. Also, 1K waterborne basecoats may be employed, and typically provide the same properties as solventborne basecoats. Any conventional waterborne base coats can be applied. Typically these are aqueous dispersions of an acrylic polymer and an alkylated melamine formaldehyde crosslinking agent. Useful compositions are taught in Nickle and Werner U.S. Pat. No. 5,314,945 issued May 24, 1994, which is hereby incorporated by reference.

Various other modifications, alterations, additions or substitutions to the method of this invention will be apparent to those skilled in the art without departing from the spirit and scope of this invention. This invention is not limited by the illustrative embodiments set forth herein, but rather is defined by the following claims.

1. A method for coating a substrate with coating composition to achieve a multiple color, chip resistant, finish, comprising:
a. applying a holdout capable chip resistant primer coating to an accent color area of a substrate;
b. applying a second, different primer surfacer coating to a non-accent area surface of a substrate;
c. applying an accent color basecoat coating wet-on-wet over the aforementioned holdout capable chip resistant primer in the accent color area of a substrate;
d. curing the above composite coating in a first bake;
e. covering the cured accent color area with a protective membrane;
f. applying a main color basecoat layer to the surface of a substrate;
g. removing said protective membrane from said cured accent color area;
h. applying over said main color basecoat layer and said cured accent color area, a clear coat composition; and
i. curing the finish in a second bake.

2. A method for coating a substrate with a coating to achieve a multiple color, chip resistant, finish, comprising:
a. applying a holdout capable chip resistant primer coating to the surface of a substrate;
b. applying an accent color basecoat coating wet-on-wet over the aforementioned holdout capable chip resistant primer in the accent color area of a substrate;
c. curing the above composite coating in a first bake;
d. covering the cured accent color area with a protective membrane;
e. applying a main color basecoat layer to the surface of a substrate;
f. removing said protective membrane from said cured accent color area;
g. applying over said main color basecoat layer and said cured accent color area, a clear coat composition; and
h. curing the finish in a second bake.

3. The method of claims 1 or 2 wherein said substrate is a transportation vehicle substrate.

4. A coated substrate prepared according to the method of claim 1 or 2.

5. The coated substrate of claim 4 wherein said substrate is a transportation vehicle substrate.
